(19) United States
(12) Patent Application Publication
(10) Pub. No.: US 2007/0251769 A1
(43) Pub. Date: Nov. 1, 2007

(54) BRAKE ASSEMBLY

(76) Inventors: Jesse D. Vandiver, Oakview, CA (US); William H. Wood, Camarillo, CA (US)

Correspondence Address: JACKSON, DEMARCO, TIDUS & PACKENPAUGH, 2815 TOWNSGATE ROAD, SUITE 200, WESTLAKE VILLAGE, CA, 91361-3010, US

(21) Appl. No.: 11/696,147

(22) Filed: Apr. 3, 2007

Related U.S. Application Data
(60) Provisional application No. 60/746,014, filed on Apr. 28, 2006.

(51) Int. Cl. B62L 1/02

(52) U.S. Cl. 188/24.12

(57) ABSTRACT

A brake assembly includes a wheel having a circular bridge and a means for applying braking forces to the bridge.

This application claims priority from Provisional Application 60/746,014 filed Apr. 28, 2006.

### BACKGROUND OF THE INVENTION

1. Field of the Invention

The present invention relates to the mechanical arts. In particular, the invention relates to a brake assembly for use with vehicles including two wheeled vehicles.

2. Discussion of the Related Art

When motor vehicles became commonplace in the early 1900's, the need for brakes better than those of wagons and carts spurred new brake technology development. These new brakes were associated with the vehicle's wheels, the wheels generally including a hub, an outer rim and a member interconnecting the hub and rim.

Initially, hub-mounted drum brakes were a popular design. But, as vehicle weight and speed increased, higher performance brakes were required to reliably maintain safe stopping distances. Modernly, these higher performance brakes have almost universally taken the form of hub-mounted disc brakes on the front wheels and hub-mounted drum brakes on the rear wheels or hub-mounted disc brakes on both the front and the rear wheels.

Such modern braking systems exert a braking force on a component rotating with the wheel. In the case of hub-mounted drum brakes, the rotating component is a brake drum that rotates with the wheel. In the case of hub-mounted disc brakes, the rotating component is a brake disc that rotates with the wheel. The vehicle is braked when a braking force imposed on the drum or disc results in a braking moment that resists continued rotation of an attached wheel. The braking moment equals the braking force multiplied by the moment arm or distance between the point of application of the force and the wheel's rotational axis. With both the hub-mounted drum type brake and the hub-mounted disc type brake, the moment arm between the applied force and the wheel's axis of rotation is relatively short as compared to the wheel's diameter and the braking force required is therefore correspondingly large.

It is a disadvantage of such types of brakes that large braking forces must be produced and further that a hub-mounted drum or disc provides only a relatively short moment arm. What is needed is a braking system that offers the advantages of disc brakes while increasing the moment arm and consequently reducing the braking force required achieve a particular level of braking performance.

### SUMMARY OF THE INVENTION

Now in accordance with the invention, there has been discovered a braking assembly that reduces the braking force required to achieve a particular level of braking performance. The brake assembly of the present invention comprises a wheel and a means for braking the wheel. In accordance with the invention is an embodiment comprising a wheel having a central hub, an outer rim and a circular bridge therebetween, a first structure interconnecting the central hub and the circular bridge and a second structure interconnecting the outer rim and the circular bridge and a means for applying braking forces to the circular bridge.

### BRIEF DESCRIPTION OF THE DRAWINGS

The present invention is described with reference to the accompanying figures. In the figures, like reference numbers indicate identical or functionally similar elements. The accompanying figures, which are incorporated herein and form part of the specification, illustrate the present invention and, together with the description, further serve to explain the principles of the invention and to enable a per son skilled in the relevant art to make and use the invention.

FIG. 1 shows in perspective view a portion of a fork and wheel assembly including an embodiment of the brake assembly of the present invention.

FIG. 2A shows an exploded view of the fork and wheel assembly and brake assembly of FIG. 1.

FIG. 2B shows a perspective view of a brake caliper assembly of the brake assembly of FIG. 1.

FIG. 3 shows a partial side view of the fork and wheel assembly and brake assembly of FIG. 1.

FIG. 4 shows a front view in partial cross-section of the fork and wheel assembly and brake assembly of FIG. 1.

FIG. 5A shows a side view of a motorcycle frame and wheels including a brake assembly in accordance with one embodiment of the present invention.

FIG. 5B shows an enlarged side view of the rear frame and wheel and brake assembly of FIG. 5A.

FIG. 5C shows a first enlarged perspective view of a portion of a rear wheel support structure of FIG. 5A.

FIG. 5D shows a second enlarged perspective view of a portion of a rear wheel support structure of FIG. 5A.

FIG. 5E shows a third enlarged perspective view of a portion of a rear wheel support structure of FIG. 5A.

### DESCRIPTION OF THE PREFERRED EMBODIMENTS

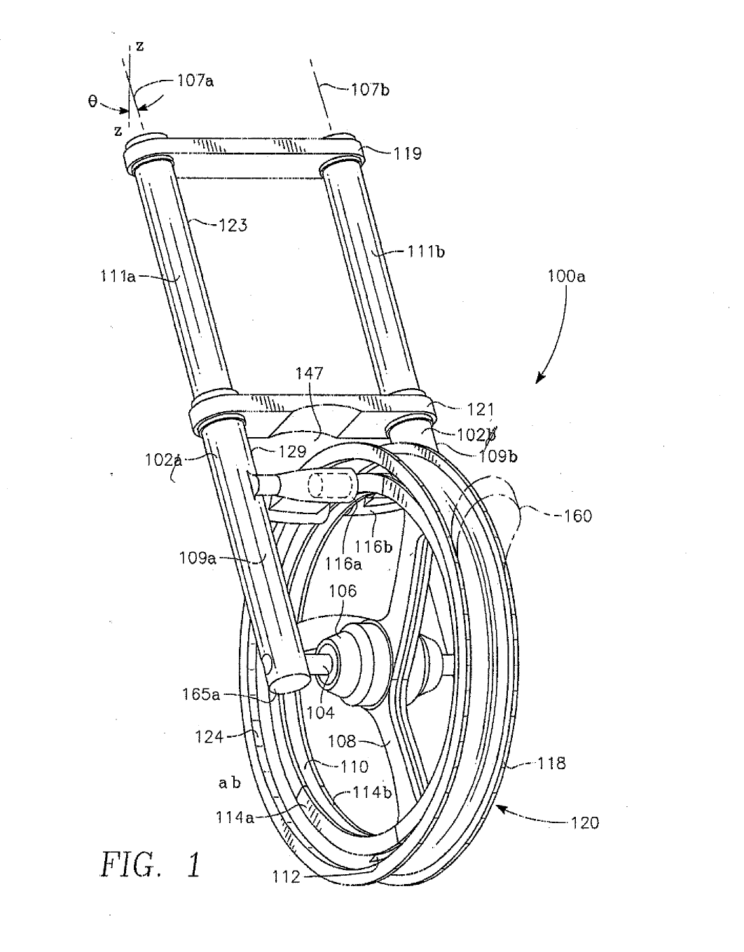

The present invention includes a wheel and a means for braking the wheel. For example, FIG. 1 shows a front fork and wheel assembly 100a including an embodiment of the braking assembly of the present invention. The fork and wheel assembly is such as might be used in motor vehicles including two-wheeled vehicles and motorcycles. Attached to the parts of the front fork 102a,b are opposed brake caliper assemblies 116a,b and an axle 104 supporting a rotatably attached wheel assembly 120.

Here, elongated first and second fork parts 102a,b define respective axes 107a,b along their major dimension. The axes are in substantially parallel relationship and are typically tilted with respect to a vertical axis z-z as described by an angle θ.

In an embodiment, a first fork brace 119 spans between the first fork part 102a and the second fork part 102b is the first fork brace 119. Generally rectangular in shape, the first fork brace is adapted to engage the respective fork parts at opposed ends of the brace and to hold the fork parts in a substantially fixed relationship.

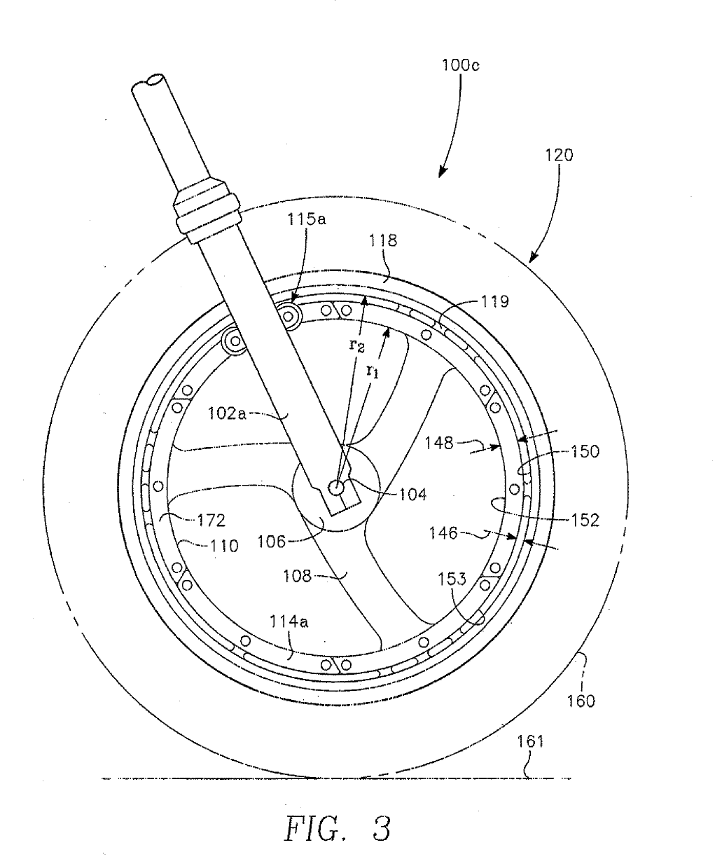

In some embodiments, a second fork brace 121 situated below the first fork brace 119 spans between the first fork part 102a and the second fork part 102b restraining separation of the fork parts. And being similar in shape to the first fork brace 119, the second fork brace is adapted to engage the respective fork parts at opposed ends of the brace and to hold the fork parts in substantially fixed relationship. Together, the first and second fork braces and the fork parts therebetween form a rectangular structure 123 from which projects the lower ends of the fork parts 165a,b engaging the axle 104 (see also FIG. 4).

In yet another embodiment, each fork part is formed by a respective plurality of engaged sections including upper 111a and lower 109a sections of one fork part 102a and upper 111a and lower 109b sections of another fork part 102b. Here, the upper fork brace 119 engages the upper sections of the fork parts and the lower fork brace 121 engages the lower sections of the fork parts. In some embodiments, the lower fork brace is spaced apart from the tire 160 by a gap 147 in the range of about 0.05 to 2.0 inches.

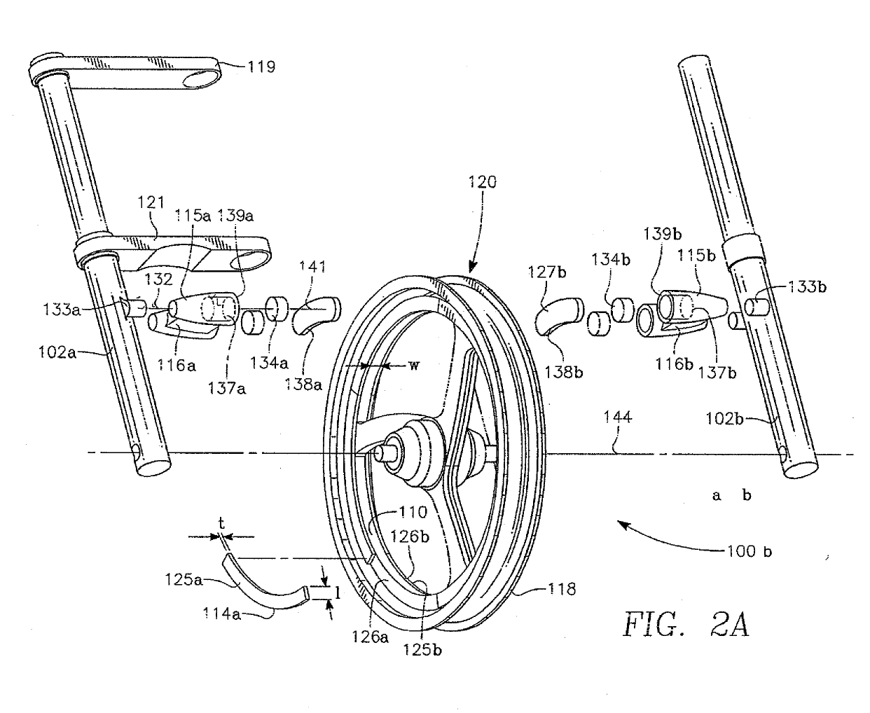

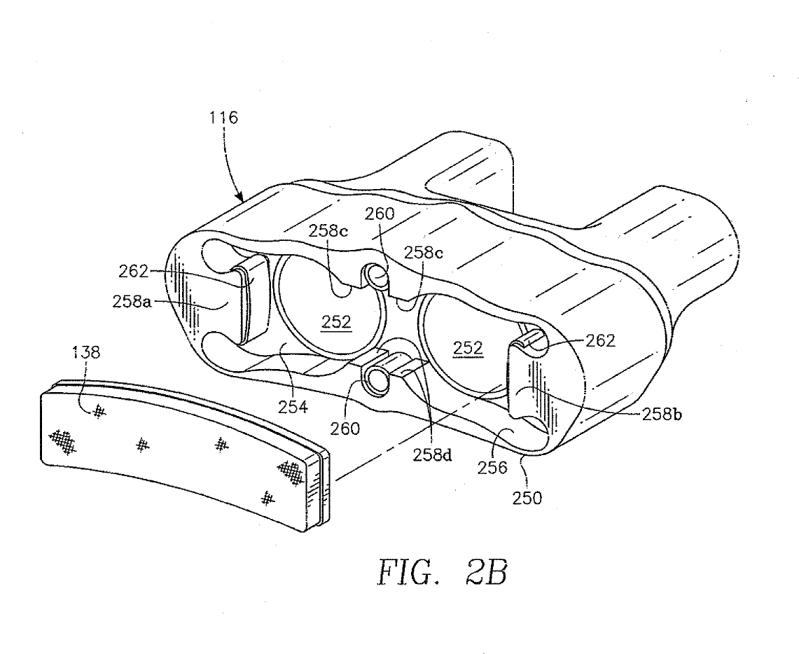

FIG. 2A shows an exploded view 100b of the fork and wheel assembly of FIG. 1. First and second brake caliper assemblies 116a,b are mounted via respective fork parts 102a,b. The brake caliper assemblies are split and thus are structurally independent. Each brake caliper assembly includes at least one caliper body 115a,b (see also FIG. 3) having a respective caliper body cylinder 137a,b. Each caliper body cylinder receives a respective piston 134a,b As a person of ordinary skill in the art will understand, the pistons may be motivated by a mechanical actuator, a pressurized fluid, or another means known in the art.

In an embodiment shown in FIG. 2B, a brake caliper assembly 116 has a projection adjacent to a brake piston bore 252 for limiting a lateral motion of the brake pad 138. In some embodiments, a circumferential skirt 250 surrounds the brake piston bore(s) 252. Created by the skirt is a brake pad container pocket 254 that contains at least a portion of the brake pad 138 and limits a lateral motion of the brake pad. In some embodiments the skirt is continuous skirt and in other embodiments the skirt is discontinuous skirt. And, in an embodiment, an inner wall 256 of the skirt has a plurality of brake pad support zones 258a-d designed to contact the brake pad and/or to hold contact parts 260, 262 designed to contact the brake pad. In some embodiments, the contact parts are supported by the support points to prevent galling or wear of the skirt. For example, clips 262 and roll-pins 260 held at the support zones come into contact with the brake pad. Suitable materials for the clips and roll pins include steel. In another embodiment, the brake pad support points are faced or coated with a material such as a suitable hard face material or abrasion resistant coating.

Each cylinder 137a,b of the brake caliper assembly 116a,b has a cylinder mouth 139a,b (see also FIG. 4) from which its piston may be projected to engage a brake pad 138a,b. In some embodiments, each brake caliper assembly includes a plurality of caliper bodies (two shown) having respective caliper body cylinders and respective pistons and in an embodiment a plurality of pistons engages a single brake pad.

In an embodiment, the brake pads 138a,b include a semi-metallic friction material which is the wear portion of the pad. The friction material is non-elastomeric and includes one or more of steel, aramid fibres, non-ferrous metals, resins, ceramic powers and other materials known to persons of ordinary skill in the art.

The brake caliper assemblies 116a,b extend from respective fork parts 102a,b such that their cylinder mouths 139a,b are opposed and their cylinders 137a,b share a common centerline 141 (see also FIG. 4). In an embodiment, brake caliper assembly mounts 133a,b on respective fork parts 102a,b provide points of attachment for the brake caliper assemblies. In another embodiment where the present invention is retrofitted onto a vehicle such as a motorcycle, pre-existing wheel fender mounts are used as brake caliper assembly mounts. And in some embodiments, the brake caliper assemblies are integral with respective fork parts.

FIG. 3 shows a side view 100c of the wheel assembly 120 of FIG. 1. The wheel assembly 120 is rotatably engaged with an axle 104 that spans between and engages the lower ends of the fork parts 165a,b. And the axle passes through a central wheel hub 106 that is supported by a first structure 108 interconnecting the hub with a circular bridge 110. The circular bridge is about equally spaced between the fork parts.

The circular bridge is spaced apart from the wheel's outer rim 118 by a second structure 119 interconnecting the circular bridge 110 and the rim. In an embodiment, a radial plane having one edge lying along the centerline of the axle 144, the plane also passing through the circular bridge, defines a cross-section of the circular bridge which is generally rectangular having a width w and a length l. And in some embodiments, the cross-section of the circular bridge has a rectangular shape with a width to length ratio greater than about 0.5.

Embodiments of the first structure 108 include a structure having an annular shape and a structure including a plurality of spokes (as shown). Embodiments of the second structure 119 include a structure having an annular shape and a structure including a plurality of posts (as shown). In various embodiments, one or more of the first structure, second structure, circular bridge 110, hub 106, and rim 118 are formed as an integral part. For example, the wheel assembly might be shaped from a monolithic aluminum block wherein the area between the hub and the circular bridge is occupied and in some embodiments filled by a first structure such as an annular first structure and the area between the circular bridge and the rim is occupied and in some embodiments filled by a second structure such as an annular second structure.

A tire 160 is typically engaged with the rim for contacting a roadway 161. In an embodiment, the dimension of the gap 146 between the circular bridge and the inner circumference of the rim 150 is in the range of about one-eighth to three-quarters of the width of the rotor segment 148. And in an embodiment, the ratio Ω=r2/r1 between the wheel's axis of rotation 144 and each of the wheel rim's inner circumference 150 and circular bridge's inner circumference 152 is in the range of about 1.05 to 1.25.

Opposed sides of the circular bridge 126a,b lie in planes that are about perpendicular to the wheel's axis of rotation 144. In an embodiment, the sides of the circular bridge serve as brake rotor surfaces. In another embodiment, separate rotor parts 114a,b may be permanently or removably fixed to the sides of the circular bridge. And in some embodiments, the contact area 127a,b between the rotor segments 114a,b and a respective brake pad 138a,b is less than about 10% (ten percent) of the total available rotor contact area 172 (see also FIG. 4).

The rotor parts 114a,b are relatively thin in comparison with their major dimension. In an embodiment the thickness t of the rotor parts is in the range of about 10% (ten percent) to 25% (twenty-five percent) of the width of the circular bridge w. In some embodiments, the rotor parts are two continuous rings having an annular shape and mounted to opposing sides of the circular bridge. And in some embodiments, the rotor parts are two sets of arc-shaped segments, a first set for use on one side of the circular bridge and a second set for use on the opposing side of the circular bridge.

The rotor parts 114a,b are thermally coupled to the circular bridge. In some embodiments the rotor segments or rotor rings are at least partially separated from the circular bridge by a film or other application of a substance such as a silicone based heat transfer compound that enhances heat transfer between the rotor parts and the circular bridge.

FIG. 4 shows a partial cross-section 100d of the assembled fork and wheel assembly of FIG. 1. Here it can be seen that the wheel assembly 120 is rotatably mounted to the fork parts 102a,b via the axle 104 and that the brake caliper assemblies 116a,b are located such that the circular bridge 110 is interposed at least in part in a gap 136 between the pistons 134a,b (brake pads not shown).

In operation, the present invention may be used for example to stop a moving vehicle and to prevent a stationary vehicle from moving. In either case, braking of the wheel 120 occurs when a force such as that provided by a pressurized fluid pushes the brake caliper pistons 134a,b toward the circular bridge 110 and causes the brake pads 138a,b to press against portions of the respective rotor parts 114a,b passing between them.

On contacting a rotor part surface 125a,b, a brake pad 138a,b applies a normal force Fan, Fbn to the rotor segment surface and frictional forces Faf=Fan*μ, Fbf=Fbn*μ lying substantially in the same plane as the rotor surface result. As is known to a person of ordinary skill in the art, such frictional forces are substantially equal to the product of the related normal force and a coefficient of friction μ. Acting through a distance d4 between the frictional force and the centerline of the axle aa, the frictional forces produce braking moments m1=Faf*d4 and m2=Fbf*d4 about the axle centerline 144 having braking moment arms d4.

Normal forces Fan, Fbn exerted by the brake caliper assemblies 116a,b are opposed by substantially equal and opposite spreading forces Fa1 and Fb1 exerted on respective fork parts 102a,b. In response to the spreading forces, the distance between the fork parts d1 tends to increase. In an embodiment, fork spreading is resisted and limited by axle forces Fa2, Fb2 imposed on the fork parts when the axle 104 is coupled with each of the fork parts. And in an embodiment, fork spreading is resisted and limited by upper fork brace forces Fa3, Fb3 when the upper fork brace 119 is coupled with each of the fork parts. And in some embodiments, fork spreading is further resisted and limited by lower fork brace forces Fa4, Fb4 when a lower fork brace 121 is coupled with each of the fork parts.

When the vehicle is stationary, operation of the present invention serves to resist an otherwise unbalanced force Fu tending to cause the vehicle to move. Such a force exists for example when the vehicle is located on an incline and a component of a gravity force tends to cause the vehicle to roll down the incline. Notably, if the wheel does not rotate, then the vehicle remains stationary assuming there is no slip between the tire 160 and the roadway it contacts 161. The braking moment required to prevent rotation of the wheel is substantially equal to the product of the unbalanced force Fu and the distance between the tire/roadway interface and the centerline of the axle d5. Therefore, assuming only one wheel is braked, when Fu*d5=Fa1*d4+Fbf*d4 the net moment about the centerline of the axle mnet is zero and a stationary vehicle remains stationary. In addition, it can be seen that for a given unbalanced force Fu, the required frictional forces Faf, Fbf and consequently the required normal forces Fan, Fbn are decreased if the braking moment arm d4 is increased. Further, where the radius of the wheel's inner circumference r2 if fixed, decreasing Ω tends to reduce the normal forces Fan, Fbn required to prevent rotation of the wheel.

And where the vehicle is in motion such that the wheel is rotating, application of the brake provides a frictional forces Faf, Fbf that tend to bring to bring the vehicle to test by dissipating the kinetic energy of the vehicle Ek As a mass in motion, the vehicle has a kinetic energy equal to one-half of its mass times its velocity squared (Ek=0.5*mass*V²). The energy dissipated by the brake Ed is approximately equal to the frictional forces multiplied by the cumulated length of the rotor segments that have passed between the brake pads during the stop (Ed=(Faf+Fbf)*(3.14*2*r1)*number of wheel revolutions)). Therefore, when braking dissipates the energy of motion Ed, the vehicle will, absent other forces, be brought to rest. In addition, it can be seen that for a given kinetic energy Ek and number of wheel revolutions, the frictional forces Faf, Fbf required for braking and consequently the required normal forces Fan, Fbn are decreased if the rotor radius r1 is increased. Further, where the radius of the wheel's inner circumference r2 is fixed, decreasing Ω tends to reduce the normal forces Fan, Fbn required to prevent rotation of the wheel.

The present invention provides for a longer radius r1 and thus a longer moment arm d4 between the axle's centerline and the frictional forces Faf, Fbf. Whether the braking duty is to prevent a stationary vehicle from moving or to bring a vehicle in motion to a standstill (or lesser speed), a longer radius r1 results in smaller required normal forces Fan, Fbn that must be applied by the brake caliper assemblies 116a,b.

Because the present invention provides braking moments comparable to traditional braking systems while utilizing smaller normal forces Fan, Fbn, the brake caliper assemblies 116a,b used in a given application may be smaller. For example, where a pressurized fluid motivates brake caliper pistons 134a,b, one or more of the brake caliper pistons may be of lesser diameter, related master cylinder piston(s) may be of lesser diameter, and pressures of the pressurized fluid may be lower. In addition, levers for actuating the brakes including master cylinder actuator levers may be shorter.

In addition, the present invention provides for improved conduction of heat away from the circular bridge 110 and rotor parts 114a,b This improved conductive cooling occurs because the circular bridge transfers the heat generated during braking to each of the first structure interconnecting the circular bridge with the hub and the second structure interconnecting the circular bridge with the rim.

Further, smaller normal forces Fan, Fbn allow for smaller areas of contact between the rotor segments and the brake pads 127. This enhances cooling of the rotor segments since at any given time, only a small portion of the available rotor contact surface 172 is being used for braking while the larger portion is being cooled by, inter alia, air. An added cooling advantage occurs here because the longer radius r1 also results in a higher relative velocity between cooling air and the rotor parts 114 which improves convective heat transfer coefficients and thus improves heat transfer from the rotor parts and/or circular bridge to the air.

Moreover, the bridge brake employs a circular bridge 110 having an inner circumferential portion 152 that is interconnected to the hubs with spokes 108 and an outer circumferential portion 153 that is interconnected to the wheel rim 118 with posts 119. Each of the spokes and posts provide improved cooling of the rotor parts 114 and/or circular bridge via conductive heat transfer paths along and to interconnected and coupled parts which are air cooled.

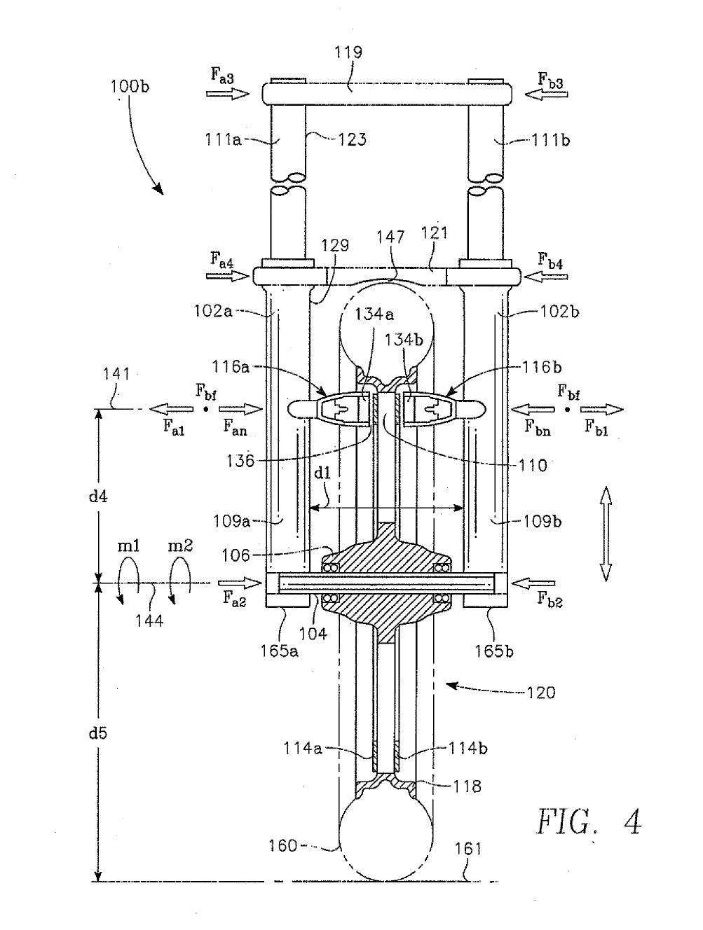

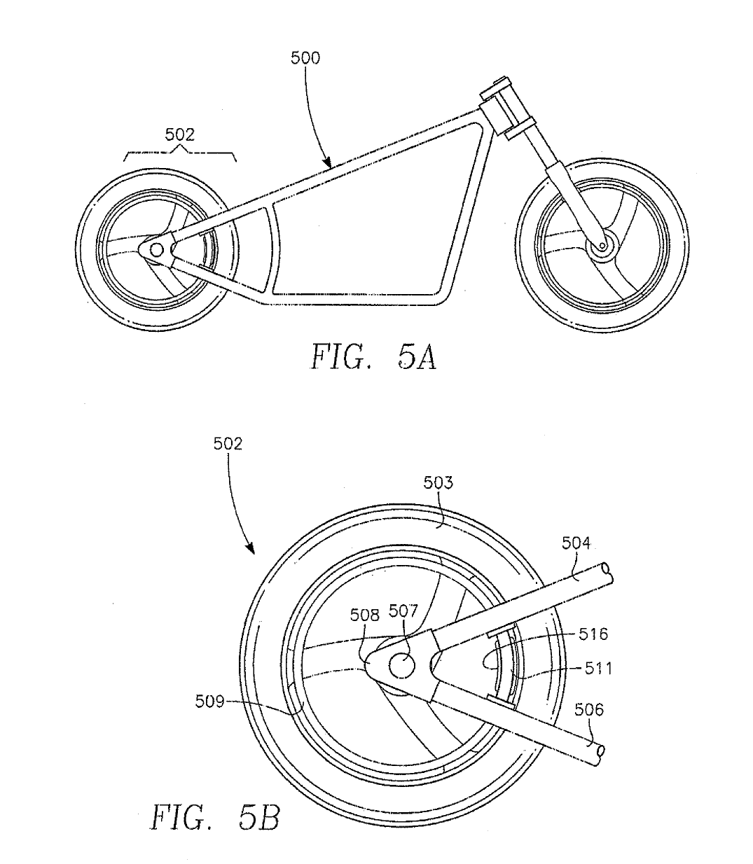

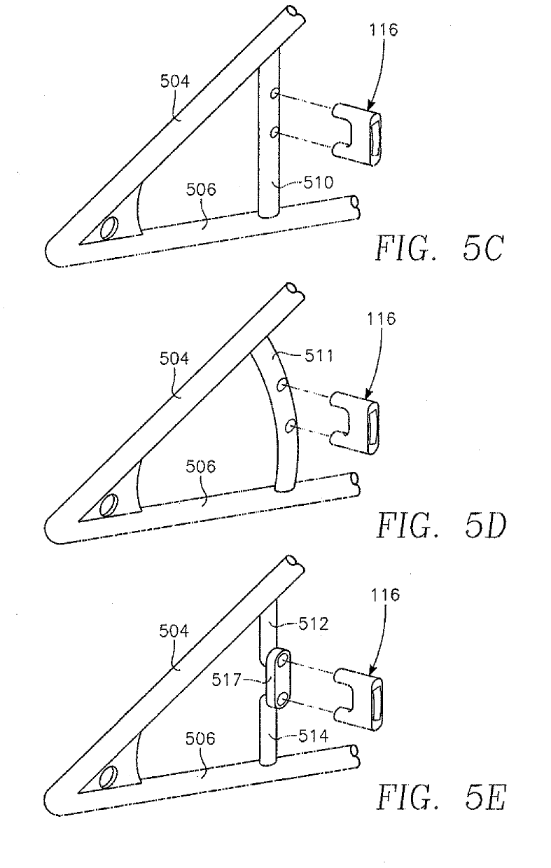

In an embodiment, the present invention is employed for braking the rear wheel of a motorcycle. As shown in FIGS. 5A and 5B, a motorcycle has a frame 500 including a rear frame portion 502. In some embodiments, this rear frame portion is articulated. The rear frame portion includes a rear wheel support structure on each side of the wheel such as an angular structure including an upper arm 504 and a lower arm 506, the arms being interconnected near a vertex 508. The rear wheel 503 is rotatably mounted to the rear wheel support structures via an axle 507 spanning therebetween. An inter-arm support 511 coupled to the upper and lower arms of each rear wheel support structure is also coupled to respective adjacent brake calipers 516.

FIG. 5C shows an embodiment wherein a substantially straight inter-arm support 510 spans between the upper 504 and lower 506 arms, being coupled at one end to the upper arm and at the opposing end to the lower arm. A brake caliper assembly 516 is coupled to inter-arm support.

FIG. 5D shows an embodiment wherein a curved inter-arm support 511 spans between the upper 504 and lower 506 arms, being coupled at one end to the upper arm and at the opposing end to the lower arm, A brake caliper assembly 516 is coupled to the inter-arm support. In some embodiments, the curvature of the inter-arm support substantially matches that of the circular bridge 509 such as is shown in FIG. 5B.

FIG. 5E shows an embodiment wherein an inter-arm support has upper and lower elbow shaped members 512, 514. The upper elbow shaped member is coupled at one end to the upper arm 504 and the lower elbow shaped member is coupled at one end to the lower arm 506. The opposite ends of the elbows are turned toward the rear wheel 503 and are coupled to a brake caliper assembly 516. In some embodiments, the turned ends of the elbows are coupled to a mounting plate 517 to which the brake caliper assembly is coupled.

While various embodiments of the present invention have been described above, it should be understood that they have been presented by way of example only, and not limitation. It will be under stood by those skilled in the art that various changes in form and details can be made therein without departing from the spirit and scope of the invention. Thus, the breadth and scope of the present invention should not be limited by any of the above-described exemplary embodiments, but should be defined only in accordance with the following claims and their equivalents

What is claimed is:

1. A brake assembly comprising:
a wheel having a central hub an outer rim and a circular bridge therebetween;
a first structure interconnecting the central hub and the circular bridge;
a second structure interconnecting the outer rim and the circular bridge; and,
a means for applying braking forces to the circular bridge.

2. The brake assembly of claim 1 further comprising:
opposed brake caliper assemblies, each assembly having at least one brake piston bore and each assembly supported by a respective wheel support structure; and,
the brake caliper assemblies operable to exert braking forces on the circular bridge.

3. The brake assembly of claim 2 wherein at least one brake caliper assembly has a projection adjacent to a brake piston bore, the projection being operable to limit a lateral motion of a brake pad.

4. The brake assembly of claim 2 wherein at least one brake caliper assembly has a circumferential skirt surrounding the brake piston bore, the skirt being operable to limit a lateral motion of a brake pad.

5. A brake assembly comprising:
a wheel having a central hub an outer rim and a circular bridge therebetween;
a first structure interconnecting the central hub and the circular bridge;
a second structure interconnecting the outer rim and the circular bridge;
a means for applying braking forces to the circular bridge;
an axle rotatably mounting the wheel between parts of a fork such that the circular bridge is about equally spaced between the parts of the fork; and,
each fork part including a first section slidably engaging a second section engaging the axle.

6. The brake assembly of claim 5 further comprising:
opposed brake caliper assemblies supported by respective second sections of the fork parts;
the brake caliper assemblies operable to exert braking forces on opposed sides of the circular bridge; and,
a fork brace spanning between and engaging the second sections of the fork parts and restraining separation of the fork parts urged by operation of the brakes.

7. The brake assembly of claim 6 wherein:
the circular bridge has a bridge inner radius;
the outer rim has an inner radius larger than the circular bridge inner radius; and,
the ratio of the outer rim inner radius to the circular bridge inner radius is between about 1.05 and 1.35.

8. The brake assembly of claim 6 further comprising two ring shaped rotor parts wherein each rotor part is removably affixed to a respective one of opposed sides of the circular bridge and wherein the rotor parts bear braking forces during operation of the brakes.

9. The brake assembly of claim 6 further comprising a first plurality of arc-shaped rotor segments removably affixed to one of the opposed sides of the circular bridge and a second plurality of arc-shaped rotor segments removably affixed to the other of the opposed sides of the circular bridge wherein the rotor segments bear braking forces during operation of the brakes.

10. The brake assembly of claim 6 further comprising:
a plurality of brake caliper pistons in each brake caliper assembly; and,
at least one brake pad interposed between each brake caliper assembly and the circular bridge wherein during operation of the brakes each brake pad is urged toward the circular bridge by at least two brake caliper pistons.

11. The brake assembly of claim 10 wherein each brake pad has a brake pad wear surface made from a semi-metallic friction material.

12. The brake assembly of claim 11 further comprising fender mounts on the respective second sections of the fork parts wherein the opposed brake caliper assemblies are attached to the respective fender mounts.

13. The brake assembly of claim 12 wherein the brake pads are not attached to the brake caliper pistons.

14. A brake assembly comprising:
a wheel including a hub, an outer rim, a first plurality of spokes and a second plurality of posts;
the spokes interconnecting the hub and a circular bridge;
the posts interconnecting the outer rim and the circular bridge; and,
a means for applying a braking force to the circular bridge.

15. A brake assembly comprising:
a wheel having a central hub an outer rim and a circular bridge therebetween;
an axle rotatably mounting the wheel between parts of a fork;
a plurality of spokes extending between the hub and the circular bridge;
a plurality of posts extending between the bridge and the outer rim;
removable rotors mounted to the circular bridge; and,
opposed brake caliper assemblies supported by parts of the fork and operable to bring respective brake pads into contact with the rotor.

16. The brake assembly of claim 15 wherein:
each fork part includes a first section slidably engaging a second section engaging the axle;
opposed brake caliper assemblies are supported by respective fork parts;
the brake caliper assemblies are operable to exert braking forces on the circular bridge; and,
a fork brace spanning between and engaging the second sections of the fork parts for preventing separation of the fork parts when braking forces are exerted on the circular bridge.

17. A brake assembly comprising:
a wheel including a circular bridge interconnecting a first plurality of spokes with a second plurality of posts;
an axle rotatably mounting the wheel between parts of a fork;
each fork part including a first section slidably engaging a second section engaging the axle;
opposed brake caliper assemblies supported by respective fork parts the brake caliper assemblies for exerting braking forces on the circular bridge; and,
a fork brace spanning between and engaging the second sections of the fork parts for preventing separation of the fork parts when braking forces are exerted on the circular bridge.

18. A brake assembly comprising:
a rotatable bridge for exchanging forces with a hub and a rim;
a first plurality of spokes coupled to the hub and a second plurality of posts coupled to the rim;
the bridge coupling the spokes and the posts; and,
a means for applying a braking force to the bridge for resisting rotation of the wheel assembly.

19. The brake assembly of claim 18 wherein the second plurality of posts is more numerous than the first plurality of spokes.

20. The brake assembly of claim 19 wherein the bridge has generally opposed sides lying in planes substantially normal to an axis of rotation of the bridge said opposed sides for bearing the braking force.

21. The brake assembly of claim 20 wherein:
the circular bridge has a bridge inner radius;
the rim has a rim inner radius larger than the circular bridge inner radius; and,
the ratio of the rim inner radius to the bridge inner radius is between about 1.05 and 1.35.

22. A brake assembly comprising:
a wheel having a central hub an outer rim and a circular bridge therebetween;
a first structure interconnecting the central hub and the circular bridge;
a second structure interconnecting the outer rim and the circular bridge;
the circular bridge having opposed sides;
a means for applying braking forces to the opposed sides of the circular bridge; and,
an axle rotatably mounting the wheel between wheel support structures such that the circular bridge is about equally spaced between the wheel support structure.

23. The brake assembly of claim 22 further comprising:
opposed brake caliper assemblies, each assembly having at least one brake piston bore and each assembly supported by a respective rear wheel support structure; and,
the brake caliper assemblies operable to exert braking forces on the opposing sides of the circular bridge.

24. The brake assembly of claim 23 wherein at least one brake caliper has a circumferential skirt surrounding a brake piston bore and containing at least a portion of a brake pad.

25. The brake assembly of claim 23 wherein the circumferential skirt is discontinuous.

26. The brake assembly of claim 23 further comprising:
first and second arms of each rear wheel support structure; and,
an inter-arm support spanning between and coupled to the first and second arms, said inter-arm support being coupled to an adjacent brake caliper assembly.

27. The brake assembly of claim 26 wherein the curvature of the inter-arm support is substantially the same as that of the circular bridge.
